(19) United States
(12) Patent Application Publication
(10) Pub. No.: US 2005/0048409 A1
(43) Pub. Date: Mar. 3, 2005

(54) Method of making an optical device in silicon

(76) Inventors: Deirdre H. Elqaq, Los Altos, CA (US); Michael T. Morse, San Jose, CA (US); Michael S. Salib, Campbell, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/652,323

(22) Filed: Aug. 29, 2003

(51) Int. Cl. G03C 5/00

(52) U.S. Cl. 430/312; 430/321; 430/315

(57) ABSTRACT

A method of forming an optical device, including forming a patterned photoresist layer over a crystalline silicon layer and implanting silicon into the crystalline silicon layer to form a selectively-amorphized silicon layer, is disclosed.

### BACKGROUND

1. Technical Field

Methods of making optical devices in silicon are disclosed. More particularly, methods of making low-index-difference, silicon-on-insulator optical devices are disclosed.

2. Brief Description of Related Technology

Some optical devices are based on structures having a localized, low index of refraction contrast. An example of a such a device is a Bragg grating, which results from periodic changes in the refractive index profile. Bragg gratings are typically formed in fibers and Group III-V materials, such as a layered structure of GaAs/AlGaAs. Gratings fabricated from Group III-V materials can suffer low yield because of the complexity of the fabrication process. Fiber gratings are difficult to integrate into a compact form.

Most optical devices made in silicon-on-insulator (SOI) materials would benefit from localized low index contrast devices, because such devices can serve to fine tune the mode structure and position.

### BRIEF DESCRIPTION OF THE DRAWINGS

FIG. 1 illustrates a method for fabricating an optical waveguide device in accordance with the disclosure.

FIG. 2 is a perspective view of an optical waveguide formed by a method in accordance with the disclosure.

### DETAILED DESCRIPTION

The disclosure generally relates to a method for forming an optical device such as a waveguide, and a device so formed.

One aspect of the disclosure is a method of forming an optical device, including forming a patterned photoresist layer over a crystalline silicon layer and implanting silicon into the crystalline silicon layer. Preferably, the method also includes removing the photoresist layer and forming a waveguide feature in the silicon layer (e.g., by patterning a photoresist mask over the waveguide area, and etching away the unmasked areas).

This method can further include forming a hard mask layer over the crystalline silicon layer before applying the photoresist layer; and patterning the hard mask layer, such as by an etch process. The type and thickness of the photoresist layer used will influence whether the use of a hard mask layer is also preferred. If the photoresist layer sufficiently blocks transmission of silicon during the implantation process to provide the desired degree of definition, then the hard mask layer can be omitted.

Preferably, the implantation of silicon into the crystalline silicon layer is performed prior to forming the waveguide feature in the resulting selectively-amorphized silicon layer. If the waveguide feature is formed in the crystalline silicon layer first, then more photoresist material would have to be deposited to fill any voids created by forming the waveguide feature.

The crystalline silicon layer is preferably on an insulator, i.e., a SOI material. Preferably, the insulator is a silicon dioxide layer, itself preferably on another layer of silicon.

The low contrast in index of refraction can be achieved by varying the silicon implant conditions. Single crystalline silicon has an index value of about 3.480 at 1550 nanometers (nm), whereas amorphous silicon typically has an index value in a range of about 3.715 to about 3.748 at 1550 nm. A low contrast in index of refraction, for example about 0.24 to about 0.27, can be achieved by selectively amorphizing silicon through high energy/dose implants of silicon to form optical devices.

A method disclosed herein can further include implanting a material subsequent to a silicon implantation to provide a relatively small change in an index of refraction. For example, doping with a material selected from the group consisting of boron, phosphorous, and combinations thereof can affect the index of refraction. Doping with boron and/or phosphorous also increases the potential of increasing the loss of a resulting device through free carrier absorption. Accordingly, implantation of only small amounts of these materials to fine tune the change of the index of refraction is preferred.

A photoresist can be either positive-acting or negative-acting. For most negative-acting photoresists, coating layer portions that are exposed to activating radiation polymerize or crosslink in a reaction between a photoactive compound and polymerizable reagents of the photoresist composition. Consequently, the exposed coating portions are rendered less soluble in a developer solution than unexposed portions. For a positive-acting photoresist, exposed portions are rendered more soluble in a developer solution while areas not exposed remain comparatively less developer soluble. Photoresist compositions in general are known to the art and are described by Deforest, Photoresist Materials and Processes, McGraw Hill Book Company, New York, Ch. 2 (1975) and by Moreau, Semiconductor Lithography, Principles, Practices and Materials, Plenum Press, New York, Ch. 2 and 4 (1988).

Photoresist materials are typically polymer resins that include a photoactive (light sensitive) compound (PAC) and an alkaline-soluble resin. Positive and negative photoresists can be classified as one or two-component systems, for example. A one-component system is typically based upon a polymer that undergoes a photochemical reaction. In a two-component system, a sensitizer molecule (e.g., monomeric) is dissolved in an inert polymeric matrix. The sensitizer undergoes the photochemical change. A common positive photoresist consists of a phenolic resin matrix and a diazonaphthoquinone sensitizer. Polymethyl methacrylate (PMMA) is a classic one-component positive resist. Other examples include: poly cis-isoprene matrix resin with bisazide sensitizer (two component negative resist), Phenol-formaldehyde copolymer (novolac) matrix resin with bisazide sensitizer (two component positive resist), polybutene-1-sulfone polymer and diazoquinone sensitizer (one-component positive resist), and a copolymer of glycidyl methacrylate and ethyl acrylate (one component negative resist).

Lithography can be used to image a pattern of photoresist onto a wafer (e.g., a silicon-on-insulator wafer, optionally having a hard mask layer formed over a crystalline silicon layer). Lithography typically requires resolution of less than 1 micrometer. The process is typically accomplished by the use of a photomask with a thin layer of light-sensitive resist material applied to the wafer. A resist is typically spun onto the wafer and baked to remove any solvent remaining in the resist material. A photomask is, for example, a glass emulsion plate with a pattern on top of it made with a hard-surface material (e.g., chromium, chromium oxide, iron oxide). Light is projected through the voids in the photomask that causes the mask pattern to become imaged on the wafer.

Various types of lithography can be used, such as optical, electron beam, and X-ray. Each type has specific advantages and disadvantages depending on the feature size of the desired device and the materials used. The description given below is for a UV system, but other systems use a similar process.

In an optical system, the resist is exposed to UV light through the photomask that contains the desired pattern. The resist either polymerizes (hardens) when exposed to light (if a negative resist is used) or unpolymerizes (if a positive resist is used). After exposure, the wafer can be developed in a solution that dissolves the excess resist and is then rinsed to remove excess developer solution. The development process can use liquid immersion or spray methods, but dry plasma methods are also used. The resulting wafer has a crystalline silicon layer (or hard mask layer, e.g., silicon dioxide, if used) exposed for the implantation pattern, with the remainder of the wafer being covered with the remaining resist coating.

Another type of lithography, one that does not need a photomask, is electron-beam direct patterning, which uses a controllable electron beam and an electron sensitive resist. Once the pattern is developed, some areas of the wafer are clear and the rest are covered with resist. Electron-beam systems result in greater resolution than optical systems and can be used to apply a pattern directly on a wafer without a photomask. X-ray systems also result in greater resolution than optical systems.

After the unreacted resist is removed, an etch process can be used to remove the exposed hard mask (e.g., silicon dioxide) layer while not removing the resist, creating the pattern in the hard mask layer. This pattern forms areas in which silicon dopants will be implanted to provide the desired pattern of differing index of refraction. Suitable hard mask materials include silicon dioxide, and nitrides such as silicon nitride. Silicon dioxide and nitrides such as silicon nitride are preferred.

Several etching processes are available. Wet chemical etching uses an acid solution (e.g., sulfuric, phosphoric, hydrogen peroxide, nitric, hydrofluoric, and hydrochloric) to etch the exposed layer of hard mask at ambient or elevated temperatures. Wet etching can also include the use of ethylene glycol, hydroxide solutions, and solutions of ammonium, ferric, or potassium compounds. However, wet etching can be less effective for etching multiple plasma-deposited layers and dry etching techniques have been developed that are more effective.

In the most commonly used dry etching technique, plasma etching, dry plasma etches are formed above the target layer by ionizing process gases under a vacuum. Although dry etching usually involves reactive halogenated gases, non-halogenated gases may also be used. Chemicals used during the dry etching process include chlorine, hydrogen bromide, carbon tetrafluoride, sulfur hexafluoride, trifluoromethane, fluorine, fluorocarbons, carbon tetrachloride, boron trichloride, hydrogen, oxygen, helium, and argon. Dry plasma etching, with one or more of carbon tetrafluoride, trifluoromethane, and argon, is preferred. A silicon dioxide plasma etch can be performed in an ambient of trifluoromethane, carbon tetrafluoride, helium, oxygen, argon, or nitrogen. Other dry etching techniques include sputter etching, ion milling, reactive etching, and reactive ion beam etching.

After etching, the remaining photoresist is removed using dry or liquid stripping compounds. The wafers can then be cleaned prior to doping. The ion implantation process is a physical deposition process that provides greater control of the number and depth of dopant atoms than does the diffusion process. In the ion implantation process, dopant sources (e.g., silicon, boron, and phosphorous) are ionized in a vacuum chamber at ambient temperature. The ionized particles are then accelerated to high velocities and imbedded into the wafer by an ion implanter (i.e., high energy implantation). The strength of the ion implanter determines the process gas usage, which commonly includes arsine, phosphine, and boron trifluoride.

After implantation, the photoresist and any hard mask material, if used, are removed. A waveguide pattern can then be formed in the crystalline silicon layer including areas of selective amorphization, for example by a dry etch process.

The use of low loss material such as disclosed herein makes possible longer gratings, because the bandwidth of the grating is related to the number of grating periods. See, e.g., Cocorullo et al., “Amorphous Silicon Waveguides and Light Modulators for Integrated Photonics Realized by Low Temperature Plasma Enhanced Chemical Vapor Deposition,” Opt. Lett. 21, 2002 (1996) (disclosing optical loss as low as 0.1 dB/cm in amorphous silicon. The optical loss of structures produced according to the method herein can also be improved by varying annealing time and/or temperature post-silicon implantation.

Similarly, the use of silicon instead of a heavier material such as germanium for implantation into silicon is more flexible from a design and manufacturing standpoint, because even at the same energy levels it is possible to implant silicon much deeper (silicon is 38% of the atomic weight of germanium, for example). Thus for example, the process disclosed herein will be advantageous in developing optical devices on SOI wavers with thick silicon layers. The process disclosed herein also eliminates the need for a solid phase regrowth process that is needed in a germanium implant process, for example.

In addition, by practice of the process disclosed herein, the processing time is dramatically lower as compared to similar devices (e.g., about two to three days versus three weeks). For example, a prior process included a trench etch, an optional gate oxidation, amorphous silicon deposition, annealing to convert the amorphous silicon to poly-Si, chemical mechanical polishing, and waveguide formation by etching. The process disclosed herein makes optional processes including trench etching, gate oxidation, amorphous silicon deposition, conversion annealing, and chemical mechanical polishing, which also enables more reproducible optical devices.

A waveguide formed according to the disclosure herein can be used, for example, as a Bragg grating in fiber and photonic optics for data transmission and signal processing. The grating is formed by causing periodic variations in the index of refraction in the crystalline silicon layer. As the contrast in index of refraction decreases, the bandwidth narrows, which is beneficial in these selective devices. The period of the index modulation can be designed to cause deflection of light at a specific wavelength, the Bragg wavelength. Typically the light at the Bragg wavelength is selectively reflected while all other wavelengths are transmitted, essentially unperturbed by the presence of the grating. By combining Bragg gratings in various arrangements, many different wavelengths can be separated and coupled out. Such gratings can be used in the construction of tunable lasers, filters, and in part of a circulator or laser cavity. For example, in distributed-feedback lasers, Bragg gratings are used in place of mirrors or facets to provide wavelength-dependent feedback into the lasing medium.

### EXAMPLES

The following example is provided to illustrate an embodiment of the invention but are not intended to limit the scope of the invention.

### Example

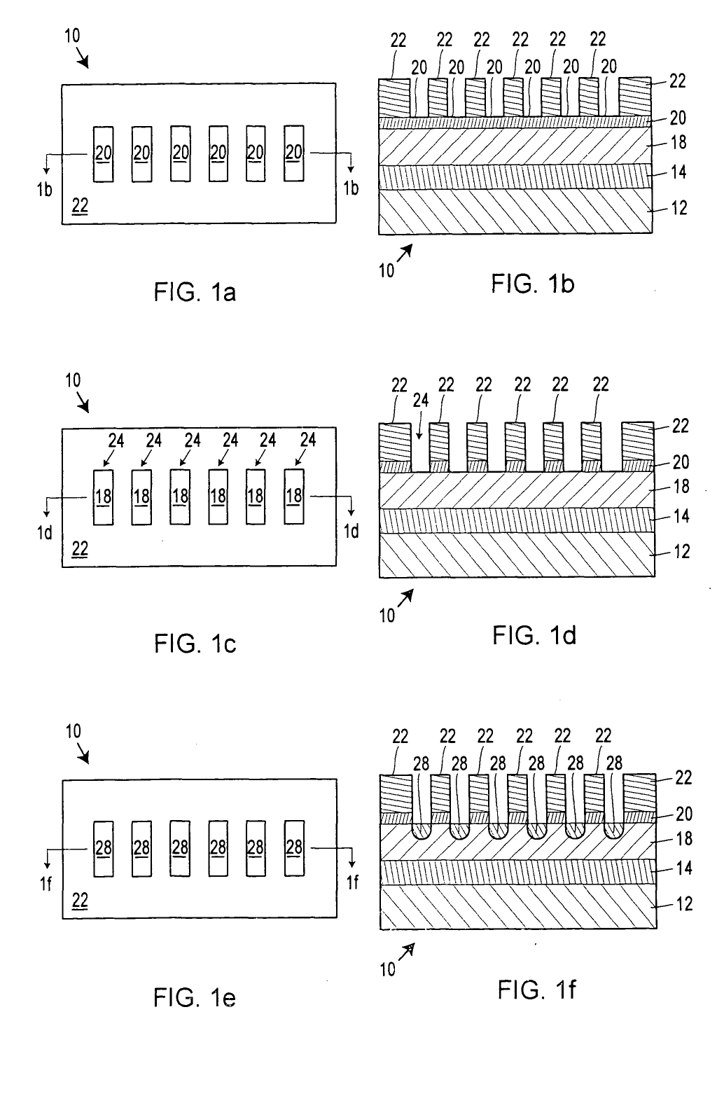

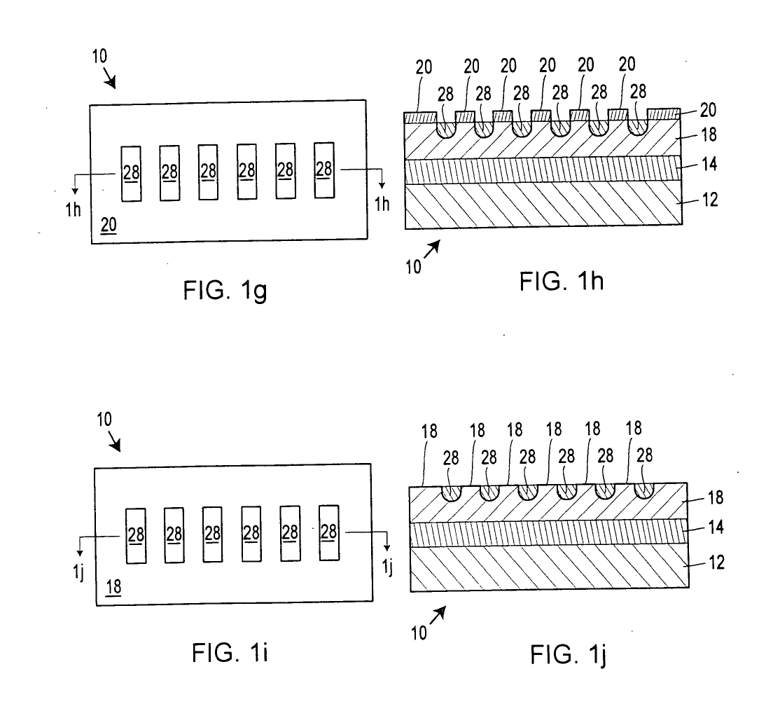

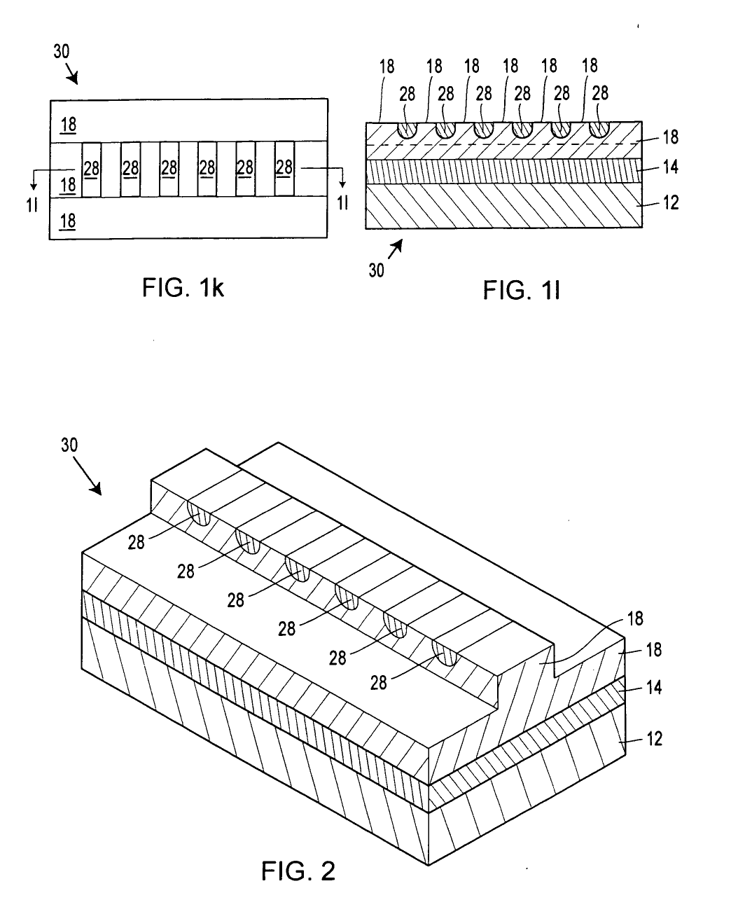

A preferred method of fabricating a optical waveguide in accordance with the disclosure is described below in connection with FIG. 1, in which the drawings in the left column (FIGS. 1a, 1c, 1e, 1g, 1i, and 1k) are top views and the drawings in the right column (FIGS. 1b, 1d, 1f, 1h, 1j, and 1l) are side views, and in connection with FIG. 2, which is a perspective view of an optical waveguide 30 formed by a method in accordance with the disclosure.

FIGS. 1a and 1b show a silicon-on-insulator wafer 10. At the stage depicted in FIGS. 1a and 1b, the wafer 10 consists of a base layer of silicon 12, an insulator layer of silicon dioxide 14, a layer of crystalline silicon 18, a hard mask layer of silicon dioxide 20, upon which has been formed a patterned layer of photoresist material 22.

The wafer 10 is subjected to a dry etch process, selectively removing silicon dioxide hard mask material in regions 24 (FIGS. 1c and 1d). Next, silicon is implanted into the crystalline silicon layer 18 at regions 24, selectively amorphizing the crystalline silicon layer 18 in regions 28 (FIGS. 1e and 1f). Next, the photoresist material is stripped from the wafer (FIGS. 1g and 1h), and then the silicon dioxide hard mask layer is etched away (FIGS. 1i and 1j). Finally, a waveguide 30 is patterned, etching away portions of the crystalline silicon layer 18 (FIGS. 1k, 1l and 2).

The foregoing description is given for clearness of understanding only, and no unnecessary limitations should be understood therefrom, as modifications within the scope of the invention may be apparent to those having ordinary skill in the art.

1. A method of forming an optical device, comprising:
forming a patterned photoresist layer over a crystalline silicon layer; and
implanting silicon into said crystalline silicon layer to form a selectively-amorphized silicon layer.

2. The method of claim 1, further comprising
removing said photoresist layer, and
forming a waveguide feature in one or more of said crystalline silicon layer and said selectively-amorphized silicon layer.

3. The method of claim 1, further comprising
forming a hard mask layer over said crystalline silicon layer before applying said photoresist layer; and
patterning said hard mask layer.

4. The method of claim 3, wherein said patterning said hard mask layer comprises dry etching said hard mask layer.

5. The method of claim 4, wherein said dry etch process comprises the use of a compound selected from the group consisting of carbon tetrafluoride, trifluoromethane, argon, and combinations thereof.

6. The method of claim 3, wherein said hard mask layer is selected from silicon oxide, silicon nitride, and combinations thereof.

7. The method of claim 1, wherein said implanting silicon into said crystalline silicon layer is performed prior to forming a waveguide feature in said crystalline silicon layer.

8. The method of claim 1, wherein said forming a patterned photoresist layer comprises applying a photoresist material over said crystalline silicon layer and patterning said photoresist material.

9. The method of claim 8, wherein said patterning said photoresist comprises a photolithography process.

10. The method of claim 1, wherein said implanting comprises high energy implantation.

11. The method of claim 1, further comprising implanting a material selected from the group consisting of boron, phosphorous, and combinations thereof subsequent to said silicon implantation to provide a relatively small change in an index of refraction contrast.

12. The method of claim 1, wherein said crystalline silicon layer is formed over an insulator layer.

13. The method of claim 12, wherein said insulator layer comprises silicon dioxide.

14. The method of claim 1, wherein the difference in index of refraction between the crystalline silicon and the selectively-amorphized silicon is in a range of about 0.24 to about 0.27.

15. A method of forming an optical waveguide, comprising:
forming a patterned photoresist layer over a crystalline silicon layer;
implanting silicon into said crystalline silicon layer to form a crystalline layer comprising regions of amorphized silicon;
removing said photoresist layer; and
forming a waveguide feature in said crystalline layer comprising regions of amorphized silicon.

16. The method of claim 15, wherein the difference in index of refraction between the crystalline silicon and the selectively-amorphized silicon is in a range of about 0.24 to about 0.27.

17. A method of forming an optical waveguide, comprising:
forming a hard mask layer comprising silicon dioxide over a crystalline silicon layer;
forming a patterned photoresist layer over said hard mask layer and said crystalline silicon layer;
patterning said hard mask layer;
implanting silicon into said crystalline silicon layer by a high energy implantation process to form a selectively-amorphized silicon layer;
removing said patterned photoresist layer;
removing the patterned hard mask layer; and
forming a waveguide feature in said selectively-amorphized silicon layer.

18. The method of claim 17, further comprising implanting a material selected from the group consisting of boron, phosphorous, and combinations thereof subsequent to said silicon implantation to provide a relatively small change in an index of refraction contrast.
